(19) United States
(12) Patent Application Publication
(10) Pub. No.: US 2013/0312892 A1
(43) Pub. Date: Nov. 28, 2013

(54) PNEUMATIC TIRE COMPRISING A TREAD SUBLAYER CONTAINING NITRILE RUBBER

(71) Applicants: Didier Vasseur, Clermont-Ferrand Cedex 9 (FR); Garance Lopitaux, Clermont-Ferrand Cedex 9 (FR); Kyoko Kobayashi, Clermont-Ferrand Cedex 9 (FR)

(72) Inventors: Didier Vasseur, Clermont-Ferrand Cedex 9 (FR); Garance Lopitaux, Clermont-Ferrand Cedex 9 (FR); Kyoko Kobayashi, Clermont-Ferrand Cedex 9 (FR)

(73) Assignees: Michelin Recherche et Technique S.A., Granges-Paccot (CH); COMPAGNIE GENERALE DES ETABLISSEMENTS MICHELIN, Clermont-Ferrand (FR)

(21) Appl. No.: 13/990,509

(22) PCT Filed: Nov. 28, 2011
(86) PCT No.: PCT/EP2011/071187

§ 371 Date: Aug. 8, 2013

(30) Foreign Application Priority Data
Nov. 30, 2010 (FR) 1059888

(51) Int. Cl. B60C 9/00

(52) U.S. Cl. CPC B60C 1/0008
USPC 152/526

(57) ABSTRACT

Radial tire having:
a crown surmounted by a tread provided with at least one radially outer elastomer layer intended to come into contact with the road when the tire is rolling;
two non-stretchable beads, two sidewalls connecting the beads to the tread, a carcass reinforcement passing into the two sidewalls and anchored in the beads;
a crown reinforcement or belt positioned circumferentially between the carcass reinforcement and the tread;
a radially inner elastomer layer, (tread “sublayer”), having a formulation different from the formulation of the radially outer elastomer layer, and positioned between the radially outer layer and the belt,
   wherein the sublayer comprises a rubber composition having at least from 30 to 100 phr of a nitrile/butadiene rubber having a content of butadiene units of between 40% and 90% by weight and more than 30 phr of a reinforcing filler. This sublayer limits the migration of plasticizers in the elastomer layer of the tread towards the inner elastomer compositions of the crown.

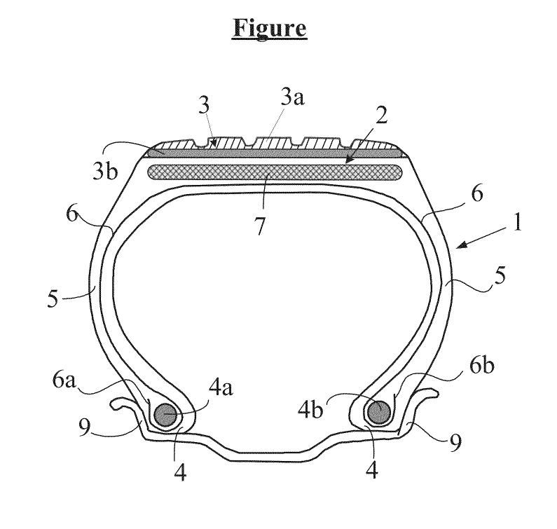

The invention relates to tires for motor vehicles and to the rubber compositions which can be used in the manufacture of such tires, more particularly to the elastomer compositions used in the crowns of tires.

In a known way, a tire has to meet a large number of often conflicting technical requirements, including a high wear resistance, a low rolling resistance and both a high dry grip and a high wet grip.

These compromises in properties were able to be improved in recent years with regard to energy-saving “Green Tires”, intended in particular for passenger vehicles, by virtue in particular of the use of novel rubber compositions of low hysteresis having the characteristic of being reinforced predominantly with specific inorganic fillers described as reinforcing, in particular with highly dispersible silicas, referred to as “HDS” (Highly Dispersible Silica), capable of rivalling, from a view point of the reinforcing power, conventional tire-grade carbon blacks.

Relatively large amounts of liquid or solid plasticizer can thus be introduced into the rubber compositions of these tire treads, as described, for example, in the documents WO 2004/022644, WO 2005/049724, WO 2005/087859 and WO 2006/061064.

However, a relatively large portion of these plasticizers may possibly migrate from the tread towards the rubber compositions making up the tire crown, such a migration resulting in possible hardening of the tread which may possibly modify the abovementioned compromises in properties.

On continuing their research, the Applicant Companies have discovered a rubber composition comprising a specific butadiene rubber which, used as tire tread sublayer, makes it possible to overcome the abovementioned disadvantage.

Thus, a first subject-matter of the invention is a radial tire for a motor vehicle, comprising:
a crown surmounted by a tread provided with at least one radially outer elastomer layer intended to come into contact with the road when the tire is rolling;
two non-stretchable beads, two sidewalls connecting the beads to the tread, a carcass reinforcement passing into the two sidewalls and anchored in the beads;
the crown being reinforced by a crown reinforcement or belt positioned circumferentially between the carcass reinforcement and the tread;
a radially inner elastomer layer, known as tread “sublayer”, having a formulation different from the formulation of the radially outer elastomer layer, this sublayer being positioned between the radially outer layer and the belt,
   the said tire being characterized in that the said sublayer comprises a rubber composition comprising at least from 30 to 100 phr of a nitrile/butadiene rubber having a content of butadiene units of between 40% and 90% by weight and more than 30 phr of a reinforcing filler.

The tires of the invention are intended in particular to equip motor vehicles of passenger type, including 4×4 vehicles (having four wheel drive) and SUV (Sport Utility Vehicle) vehicles, two-wheel vehicles (in particular motorcycles), such as industrial vehicles chosen in particular from vans and heavy-duty vehicles (i.e., underground, bus, heavy road transport vehicles, such as lorries, tractors or trailers, or off-road vehicles, such as agricultural vehicles or earth-moving equipment).

The invention and its advantages will be easily understood in the light of the description and implementational examples which follow, and also the single figure relating to these examples which diagrammatically represents, in radial cross section, an example of a radial tire in accordance with the invention.

### I—DEFINITIONS

In the present patent application:
“bead” is understood to mean, in a known way, the non-stretchable portion of the tire radially internally adjacent to the sidewall, the base of which is intended to be fitted onto a rim seat of a vehicle wheel;
“diene elastomer (or without distinction rubber)” is understood to mean, in a known way, an elastomer resulting at least in part (that is to say, a homopolymer or a copolymer) from diene monomer(s) (i.e., bearing two conjugated or non-conjugated carbon-carbon double bonds);
“sidewall” is understood to mean, in a known way, the portion of the tire, generally having a low flexural stiffness, located between the crown and the bead;
“phr” is understood to mean, in a known way, parts by weight per hundred parts of elastomer (of the total of the elastomers, if several elastomers are present);
“radial” is understood to mean, in a known way, a direction passing through the axis of rotation of the tire and normal to the latter; this direction can be “radially internal (or inner)” or “radially external (or outer)”, according to whether it is directed towards the axis of rotation of the tire or towards the outside of the tire.

Moreover, in the present description and unless expressly indicated otherwise, all the percentages (%) shown are % by weight; likewise, any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

### II—MEASUREMENTS AND TESTS USED

The rubber compositions used in the tires according to the invention are characterized after curing, as indicated below.

### II.1—Tensile Tests

These tests make it possible to determine the elasticity stresses and the properties at break. Unless otherwise indicated, they are carried out in accordance with French Standard NF T 46-002 of September 1988. The nominal secant moduli (or apparent stresses, in MPa) are measured in second elongation (i.e., after a cycle of accommodation to the degree of extension planned for the measurement itself) at 10% and 100% elongation (denoted EM10 and EM 100). All these tensile measurements are carried out under standard conditions at temperature (23±2° C.) and hygrometry (50±5% relative humidity), according to French Standard NF T 40-101 (December 1979).

### II.2—Dynamic Properties

The dynamic properties are measured on a viscosity analyser (Metravib VA4000), according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, is recorded.

A strain amplitude sweep is carried out from 0.1% to 50% (outward cycle) and then from 50% to 1% (return cycle). The result made use of is the loss factor tan(δ). The maximum value of tan(δ) observed, denoted tan(δ)ₘₐₓ, at 23° C. is shown for the return cycle.

It should be remembered that, in a way well known to a person skilled in the art, the value of tan(δ)ₘₐₓ at 23° C. is representative of the hysteresis of the material and thus of the rolling resistance: the lower the value of tan(δ)ₘₐₓ at 23° C., the lower the rolling resistance.

### II.3—Test of Migration of the Plasticizers

A test specimen with the shape of a parallelepiped, exhibiting a square cross section with a side length of 10 cm and with a total thickness of 16 mm, is used. It is composed of three layers of elastomer compositions stacked along the thickness: in order, of a first layer with a thickness of 7 mm composed of a composition representative of the tread, then of a second layer with a thickness of 2 mm composed of a composition representative of a tread sublayer and of a third layer with a thickness of 7 mm composed of a composition representative of a tire crown ply (belt).

The test specimens thus prepared are cured between two curing plates for approximately 20 min at 175° C. They are subsequently subjected to an accelerated ageing at approximately 75° C. for approximately 3 weeks.

The test specimens and the three layers are then cut in their middle, into two equal parts, in the direction of the thickness. The slice of the sample thus cut out is analysed along the thickness. The content (expressed in %) of plasticizer present on the slice, in the thickness of the first layer, at a distance D (expressed in mm) from the interface between the first layer and the second layer, is measured.

Mid-infrared microscopy is used to carry out these measurements. Automatic acquisition of the IR spectra is carried out on the slice of the sample, by reflection in the first layer. The apparatus used is a “Brucker Vertex70” Fourier-transform mid-infrared (FTIR) spectrometer equipped with a “Brucker Hyperion3000” infrared microscope with “MCT DigiTect Midband” detector, ATR (Attenuated Total Reflectance, magnification: ×20, diameter analysed 100 μm) objective and a computer-controllable motorized sample stage. Each spectrum is acquired in ATR mode on 32 accumulations of spectra between 650 and 4000 cm⁻¹ with a resolution of 2 cm⁻¹. The spectra are analysed according to the Beer-Lambert law generalized for a multicomponent system. Acquisitions of the spectra of the starting materials, carried out under the abovementioned conditions, make possible deconvolution of the mixture (plasticizer+vulcanized elastomeric matrix) spectra into elastomeric component, on the one hand, and plasticizer component, on the other hand. The coefficient associated with the plasticizer component is directly proportional to the content of plasticizer, expressed in percentage.

### III—DETAILED DESCRIPTION OF THE INVENTION

The tire of the invention thus has the essential characteristic of being provided with a tread sublayer comprising a rubber composition which comprises at least from 30 to 100 phr of a nitrile/butadiene rubber having a content of butadiene units of between 40% and 90% by weight and more than 30 phr of reinforcing filler, which components will be described in detail below.

### III.1—Nitrile/Butadiene Rubber

The nitrile/butadiene rubber is, by definition, a copolymer based on at least one butadiene monomer and one nitrile monomer, that is to say a monomer bearing a nitrile functional group.

For a butadiene content of between 40% and 90% by weight, the nitrile/butadiene rubber has proved to exhibit an optimum adhesion with the surrounding rubber compositions; below 40% by weight, the adhesion is regarded as insufficient. Preferably, the butadiene content is between 50% and 80% by weight.

The butadiene monomers which are suitable are in particular 1,3-butadiene, 2,3-dimethyl-1,3-butadiene, 2-methyl-1,3-butadiene, 2-ethyl-1,3-butadiene, 2-phenyl-1,3-butadiene or the mixtures of these dienes. Use is preferably made, among these conjugated dienes, of 1,3-butadiene or 2-methyl-1,3-butadiene, more preferably 1,3-butadiene.

The nitrile monomers are, for example, acrylonitrile, methacrylonitrile, ethylacrylonitrile, crotononitrile, 2-pentenonitrile or the mixtures of these compounds, among which acrylonitrile is preferred.

According to another preferred embodiment, the nitrile/butadiene rubber has a glass transition temperature (Tg, measured according to ASTM D3418) within the range from 0° C. to −60° C., more preferentially within the range from −5° C. to −50° C. The Tg can in particular be adjusted in these temperature ranges by virtue of the amounts of styrene and/or butadiene present in the polymer.

The nitrile/butadiene rubber is preferably selected from the group consisting of copolymers of butadiene and acrylonitrile (NBRs), terpolymers of styrene, butadiene and acrylonitrile (SNBRs) and the mixtures of these copolymers.

Below 30 phr of nitrile/butadiene rubber, the targeted technical effect is insufficient, the sublayer losing its leaktightness properties with regard to the plasticizers of the tread. For these reasons, the content of nitrile/butadiene rubber is preferably within a range from 40 to 100 phr, more preferably still within a range from 50 to 100 phr. The nitrile/butadiene rubber can also constitute the only elastomer present in the sublayer, consequently at a content by weight of 100 phr.

According to a preferred embodiment of the invention, the nitrile rubber is an NBR rubber. The NBR thus has a content of nitrile monomer of between 10% and 60%, preferably between 20% and 50%, particularly between 25% and 45%, by weight. The NBRs described above are commercially available, in particular sold by Lanxess under the name “Krynac 3370F”, which product comprises approximately 37% by weight of acrylonitrile and has a glass transition temperature of approximately −27° C.

According to another specific embodiment of the invention, the nitrile/butadiene rubber is an SNBR. SNBR rubbers are well known; they have been described in particular, along with their application as tire treads, in the documents EP 0 366 915, EP 0 537 640 or U.S. Pat. No. 5,225,479, EP 0 736 399 or U.S. Pat. No. 5,859,115.

The styrene monomers which can be used are preferably those which comprise from 8 to 16 carbon atoms in the molecule, such as styrene, α-methylstyrene, 2-methylstyrene, 3-methylstyrene, 4-methylstyrene, 4-cyclohexylstyrene, 4-(p-toluene) styrene, p-chlorostyrene, p-bromostyrene, 4-(tert-butyl)styrene or the mixtures of these compounds, among which styrene is more preferred.

According to a more specific embodiment of the invention, the SNBR has a content of nitrile monomer of between 5% and 30% by weight.

The SNBRs described above are commercially available, in particular sold by Lanxess under the name “Krynac VP KA 8683”, which product comprises approximately 30% by weight of styrene and approximately 10% by weight of acrylonitrile and has a glass transition temperature of approximately −34° C.

According to another specific embodiment, the rubber composition of the sublayer of the tread of the tire according to the invention additionally comprises at least one second diene elastomer other than the nitrile/butadiene rubber, this optional elastomer being present according to a content of 0 to 70 phr, preferably of at most 60 phr, more preferably of at most 50 phr.

The second diene elastomer is preferably selected from the group consisting of polybutadienes (BRs), synthetic polyisoprenes (IRs), natural rubber (NR), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs) and the mixtures of these elastomers.

More preferably, the second diene elastomer is selected from the group consisting of natural rubber, polybutadienes and the mixtures of these elastomers.

These second diene elastomers can, for example, be block, random, sequential or microsequential elastomers and can be prepared in dispersion or in solution; they can be coupled and/or star-branched or else be functionalized with a coupling and/or star-branching or functionalization agent.

The following are suitable in particular: polybutadienes having a content (mol %) of 1,2- units of between 4% and 80% or those having a content (mol %) of cis-1,4- units of greater than 80%, polyisoprenes, butadiene/styrene copolymers and in particular those having a Tg (glass transition temperature, measured according to ASTM D3418) between 0° C. and −70° C. and more particularly between −10° C. and −60° C., a styrene content of between 5% and 60% by weight and more particularly between 20% and 50%, a content (mol %) of 1,2- bonds of the butadiene part of between 4% and 75% and a content (mol %) of trans-1,4- bonds of between 10% and 80%, butadiene/isoprene copolymers, in particular those having an isoprene content of between 5% and 90% by weight and a Tg of −40° C. to −80° C., or isoprene/styrene copolymers, in particular those having a styrene content of between 5% and 50% by weight and a Tg of between −25° C. and −50° C.

According to another specific embodiment, the second diene elastomer is an isoprene elastomer. Mention will in particular be made, among isoprene copolymers, of isobutene/isoprene copolymers (butyl rubber—IIRs), isoprene/styrene copolymers (SIRs), isoprene/butadiene copolymers (BIRs) or isoprene/butadiene/styrene copolymers (SBIRs). This isoprene elastomer is preferably natural rubber or a synthetic cis-1,4-polyisoprene; use is preferably made, among these synthetic polyisoprenes, of polyisoprenes having a content (mol %) of cis-1,4- bonds of greater than 90%, more preferably still of greater than 98%.

### III.2—Reinforcing Filler

Use may be made of any type of reinforcing filler known for its abilities to reinforce a rubber composition which can be used in the manufacture of tires, for example an organic filler, such as carbon black, a reinforcing inorganic filler, such as silica, or also a blend of these two types of filler, in particular a blend of carbon black and silica.

All carbon blacks, in particular “tire grade” blacks, are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or also, depending on the applications targeted, of the blacks of higher series (for example N660, N683 or N772 blacks). The carbon blacks might, for example, be already incorporated in an isoprene elastomer in the form of a masterbatch (see, for example, Applications WO 97/36724 or WO 99/16600).

Mention may be made, as examples of organic fillers other than carbon blacks, of the functionalized polyvinyl organic fillers as described in Applications WO-A-2006/069792, WO-A-2006/069793, WO-A-2008/003434 and WO-A-2008/003435.

“Reinforcing inorganic filler” should be understood, in the present patent application, by definition, as meaning any inorganic or mineral filler (whatever its colour and its origin, natural or synthetic), also known as “white filler”, “clear filler” or even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

The physical state under which the reinforcing inorganic filler is provided is not important, whether it is in the form of a powder, of microbeads, of granules, of beads or any other appropriate densified form. Of course, reinforcing inorganic filler is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET surface and a CTAB specific surface both of less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16837.

The reinforcing inorganic filler used, in particular if it is silica, preferably has a BET surface of between 45 and 400 m²/g, more preferably of between 60 and 300 m²/g.

The content of total reinforcing filler (carbon black and/or reinforcing inorganic filler, such as silica) is greater than 30 phr, preferably of between 30 and 100 phr, more preferably between 35 and 85 phr. Below 30 phr, the cohesion of the sublayer is judged to be insufficient; above 100 phr, the risk arises of excessive stiffening of the sublayer.

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use is made in particular of silane polysulphides, referred to as “symmetrical” or “unsymmetrical” depending on their specific structure, as described, for example, in Applications WO 03/002648 (or US 2005/016651) and WO 03/002649 (or US 2005/016650).

“Symmetrical” silane polysulphides corresponding to the following general formula (I):

Z-A-Sₓ-A-Z, in which: (I)
x is an integer from 2 to 8 (preferably from 2 to 5);
A is a divalent hydrocarbon radical (preferably C₁-C₁₈ alkylene groups or C₆-C₁₂ arylene groups, more particularly C₁-C₁₀, in particular C₁-C₄, alkylenes, especially propylene);
Z corresponds to one of the formulae below:

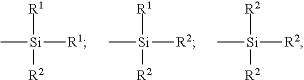

in which:
the R¹ radicals, which are unsubstituted or substituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, in particular C₁-C₄ alkyl groups, more particularly methyl and/or ethyl),
the R² radicals, which are unsubstituted or substituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl), are suitable in particular, without the above definition being limiting.

In the case of a mixture of alkoxysilane polysulphides corresponding to the above formula (I), in particular the usual mixtures available commercially, the mean value of the “x” indices is a fractional number preferably of between 2 and 5, more preferably in the vicinity of 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl)polysulphides (in particular disulphides, trisulphides or tetrasulphides), such as, for example, bis(3-trimethoxysilylpropyl) or bis(3-triethoxysilylpropyl)polysulphides. Use is in particular made, among these compounds, of bis(3-triethoxysilylpropyl)tetrasulphide, abbreviated to TESPT, of formula [(C₂H₅O)₃Si(CH₂)₃S₂]₂, or bis(triethoxysilylpropyl)disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl)polysulphides (in particular disulphides, trisulphides or tetrasulphides), more particularly bis(monoethoxydimethylsilylpropyl)tetrasulphide, as described in Patent Application WO 02/083782 (or US 2004/132880).

Mention will in particular be made, as coupling agent other than alkoxysilane polysulphide, of bifunctional POSs (polyorganosiloxanes) or of hydroxysilane polysulphides (R²═OH in the above formula VIII), such as described in Patent Applications WO 02/30939 (or U.S. Pat. No. 6,774,255) and WO 02/31041 (or US 2004/051210), or of silanes or POSs carrying azodicarbonyl functional groups, such as described, for example, in Patent Applications WO 2006/125532, WO 2006/125533 and WO 2006/125534.

In the rubber compositions in accordance with the invention, the content of coupling agent is preferably between 4 and 12 phr, more preferably between 4 and 8 phr.

A person skilled in the art will understand that use might be made, as filler equivalent to the reinforcing inorganic filler described in the present section, of a reinforcing filler of another nature, in particular organic nature, provided that this reinforcing filler is covered with an inorganic layer, such as silica, or else comprises, at its surface, functional sites, in particular hydroxyl sites, requiring the use of a coupling agent for establishing the bond between the filler and the elastomer.

III.3—Various additives

The elastomer composition of the sublayer of the tread can also comprise all or a portion of the usual additives generally used in rubber compositions for tires, such as, for example, protection agents, such as chemical antiozonants, antioxidants, optional plasticizing agents or extending oils in a small amount, preferably of less than 20 phr, in particular of less than 10 phr, whether the latter are of aromatic or nonaromatic nature, in particular very slightly aromatic or nonaromatic oils, for example of the naphthenic or paraffinic type, having a high or preferably a low viscosity, MES or TDAE oils, plasticizing hydrocarbon resins having a high Tg, tackifying resins, reinforcing resins, methylene acceptors or donors, a crosslinking system based either on sulphur or on sulphur donors and/or on peroxide and/or on bismaleimides, vulcanization accelerators or vulcanization activators.

The compositions of the sublayer of the tread can also comprise coupling activators, when a coupling agent is used, covering agents for the inorganic filler, when an inorganic filler is used, or more generally processing aids capable, in a known way, by virtue of an improvement in the dispersion of the filler in the rubber matrix and of a lowering in the viscosity of the compositions, of improving their property of processability in the raw state; these agents are, for example, hydroxysilanes or hydrolysable silanes, such as alkylalkoxysilanes, polyols, polyethers, amines, or hydroxylated or hydrolysable polyorganosiloxanes.

### III.4—Preparation of the Compositions

The compositions used in the tread sublayers according to the invention can be manufactured in appropriate mixes using two successive preparation phases well known to a person skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) down to a lower temperature, typically of less than 110° C., for example between 40° C. and 100° C., during which finishing phase the crosslinking system is incorporated.

The process for preparing such compositions comprises, for example, the following stages:
incorporating, in a mixer, into at least from 30 to 100 phr of the nitrile/butadiene rubber having a butadiene content of between 40% and 90% by weight, during a first (“non-productive”) step, more than 30 phr, preferably between 30 and 100 phr, of the reinforcing filler, everything being kneaded thermomechanically (for example in one or more stages), until a maximum temperature of between 110° C. and 190° C. is reached;
cooling the combined mixture to a temperature of less than 100° C.;
subsequently incorporating, during a second (“productive”) stage, a crosslinking system;
kneading everything up to a maximum temperature of less than 110° C.

By way of example, the non-productive phase is carried out in a single thermomechanical stage during which, to begin with, all the necessary base constituents (nitrile/butadiene rubber and reinforcing filler) are introduced into an appropriate mixer, such as a normal internal mixer, and then, subsequently, for example after kneading for one to two minutes, the other additives, optional additional covering agents for the filler or processing aids, with the exception of the crosslinking system, are introduced. The total duration of the kneading, in this non-productive phase, is preferably between 1 and 15 min.

After cooling the mixture thus obtained, the crosslinking system is then incorporated in an external mixer, such as an open mill, maintained at a low temperature (for example between 40° C. and 100° C.). The combined mixture is then mixed (productive phase) for a few minutes, for example between 2 and 15 min.

The crosslinking system proper is preferably based on sulphur and on a primary vulcanization accelerator, in particular on an accelerator of the sulphonamide type. Various known secondary vulcanization accelerators or vulcanization activators, such as zinc oxide, stearic acid, guanidine derivatives (in particular diphenylguanidine), and the like, come to be added to this vulcanization system, being incorporated during the first non-productive phase and/or during the productive phase. The sulphur content is preferably between 0.5 and 3.0 phr and the content of the primary accelerator is preferably between 0.5 and 5.0 phr.

Use may be made, as (primary or secondary) accelerator, of any compound capable of acting as accelerator of the vulcanization of diene elastomers in the presence of sulphur, in particular accelerators of the type consisting of thiazoles and their derivatives or accelerators of the type consisting of thiurams or zinc dithiocarbamates. These accelerators are more preferably selected from the group consisting of 2-mercaptobenzothiazyl disulphide (abbreviated to “MBTS”), N-cyclohexyl-2-benzothiazolesulphenamide (abbreviated to “CBS”), N,N-dicyclohexyl-2-benzothiazolesulphenamide (abbreviated to “DCBS”), N-tert-butyl-2-benzothiazolesulphenamide (abbreviated to “TBBS”), N-tert-butyl-2-benzothiazolesulphenimide (abbreviated to “TBSI”), zinc dibenzyldithiocarbamate (abbreviated to “ZBEC”) and the mixtures of these compounds. Preferably, a primary accelerator of the sulphenamide type is used.

The final composition thus obtained can subsequently be calendered, for example in the form of a sheet or of a plaque, in particular for laboratory characterization, or else extruded, for example in order to form a rubber profiled element used in the manufacture of a tread sublayer.

The invention relates to the tires described above both in the raw state (that is to say, before curing) and in the cured state (that is to say, after crosslinking or vulcanization).

### IV—EXAMPLES OF THE IMPLEMENTATION OF THE INVENTION

### IV.1—Preparation of Compositions

The tests which follow are carried out in the following way: the nitrile/butadiene rubber, the reinforcing filler and the various other ingredients, with the exception of the vulcanization system, are successively introduced into an internal mixer (final filling degree: approximately 70% by volume), the initial vessel temperature of which is approximately 60° C. Thermomechanical working is then carried out (non-productive phase) in one stage, which lasts in total approximately from 3 to 4 min, until a maximum “dropping” temperature of 165° C. is reached. The mixture thus obtained is recovered and cooled, and then sulphur and an accelerator of sulphenamide type are incorporated on a mixer (homofinisher) at 30° C., everything being mixed (productive phase) for an appropriate time (for example, between 5 and 12 min).

The compositions thus obtained are subsequently calendered, either in the form of plaques (thickness of 2 to 3 mm) or of thin sheets of rubber, for the measurement of their physical or mechanical properties, or extruded in the form of a tread sublayer.

### IV.2—Tire of the Invention

The rubber composition described above is thus used, in the tire of the invention, as sublayer positioned circumferentially inside the crown of the tire, between, on the one hand, the radially outermost part of its tread, i.e. the portion intended to come into contact with the road during running, and, on the other hand, the belt which reinforces said crown.

It should thus be understood that the sublayer is positioned:
either under the tread (that is to say, radially internally with respect to this tread), between the tread and the belt;
or in the tread itself but, in this case, under the tread patterned portion (that is to say, radially internally with respect to this portion) which is intended to come into contact with the road during the rolling of the tire.

The single appended figure represents, in radial cross section, in a highly diagrammatic manner (in particular without observing a specific scale), a preferred example of a pneumatic tire for a motor vehicle comprising a radical carcass reinforcement, in accordance with the invention.

In this figure, the pneumatic tire (1) represented diagrammatically comprises a crown 2 surmounted by a tread 3 (for simplicity, comprising a very simple tread pattern), the radially outer part (3a) of which is intended to come into contact with the road, and two non-stretchable beads (4), in which a carcass reinforcement (6) is anchored. The crown 2, joined to the said beads (4) via two sidewalls (5), is, in a way known per se, reinforced by a crown reinforcement or “belt” (7) at least partly made of metal and radially outer with respect to the carcass reinforcement (6), for example composed of at least two superimposed crossed plies reinforced by metal cables.

The carcass reinforcement (6) is in this instance anchored in each bead (4) by winding around two bead wires (4a, 4b), the turn-up (6a, 6b) of this reinforcement (6) being, for example, positioned towards the outside of the tire (1), which is in this instance represented fitted onto its rim (9). Of course, this tire (1) additionally comprises, in a known way, an inner rubber or elastomer layer (commonly known as “inner liner”) which defines the radially inner face of the tire and which is intended to protect the carcass ply from the diffusion of air originating from the space interior to the tire.

The tire according to the invention thus has the characteristic of comprising a radially inner elastomer layer (3b), referred to as “sublayer”, of the tread, with a formulation different from the formulation of the radially outer elastomer layer (3a) of the tread, this sublayer being positioned between the radially outer layer (3a) and the belt (7).

### IV.3—Rubber Tests

The tests which follow demonstrate the excellent leaktightness properties of a tread sublayer according to the invention with regard to the risk of migration of the plasticizers, originating from the tread, towards the internal compositions of the crown of the tire.

The rubber composition of this tread is a conventional composition based on SBR and NR, on silica and on approximately 50 phr of a mixture of two plasticizers: a liquid plasticizer (sunflower oil comprising 85% by weight of oleic acid) and a plasticizing hydrocarbon resin (polylimonene resin).

For the requirements of these tests, two rubber compositions for a tread sublayer were prepared as indicated above, one in accordance with the invention (hereinafter denoted C.2) and one not in accordance with the invention (control composition hereinafter denoted C.1).

Their formulations (expressed in phr) are presented in the appended Table 1.

The composition C.1 is a control composition, conventionally based on BR and NR, which can be used in tread sublayers of “Green Tires” for passenger vehicles. The composition C.2 is based on 100 phr of NBR having approximately 33% by weight of acrylonitrile units, i.e. approximately 67% by weight of butadiene units. Their properties after curing (vulcanization) have been summarized in the appended Table 2.

It is noted first of all that the composition C.2 exhibits, after curing, low-strain stiffness (EM10) properties which are superior to those of the control composition, which is an indicator recognizable to a person skilled in the art of an improvement in the reinforcing of the compositions, furthermore of an enhanced drift thrust and, in the end, of an improved handling of the tires.

It is subsequently noted that the composition C.2 according to the invention exhibits a value of tan(δ)ₘₐₓ at 23° C. which is slightly greater than that of the control composition C.1, which is synonymous with a level of hysteresis (and thus of rolling resistance) which is admittedly greater than that of the control solution but nevertheless remains at a level entirely acceptable to a person skilled in the art.

Finally, the measurements of the total content of plasticizer (liquid and solid) present in the first layer representative of the tread, at different distances D (from the middle of the first layer down to the interface with the second layer, i.e. D varying from 3.5 mm to 0 mm) from the interface with the second layer representative of the sublayer, have been listed in Table 3, these measurements being carried out in accordance with the test described above in section II-3.

It is noted that the measurements on the representative samples of the tire according to the invention (using the composition C.2 as sublayer) are unchanging (100%), whatever the distance D (3.5 to 0 mm) with respect to the interface between first and second layers, whereas these values rapidly decrease (from 100% to 60%), in the case of the control composition (C.1), when the interface is approached; it is noted that, at the interface (D equal to 0 mm), the composition of the tread of the control solution, after ageing, has thus lost 40% of its initial plasticizer content.

This thus clearly illustrates the effectiveness of the sublayer according to the invention as barrier to plasticizer, with regard to the risk of migration from the tread towards the other inner compositions of the crown of the tire.

To summarize, the results of these tests demonstrate that the use of a nitrile/butadiene rubber, at the recommended contents, in the composition of the sublayer of the tire according to the invention makes it possible to solve the problem of the risk of migration of the plasticizers present in the tread towards the internal elastomer compositions making up the crown of the tire.

Furthermore, the sublayer based on nitrile/butadiene rubber exhibits a low-strain stiffness which is superior to that of the conventional sublayer (control composition), synonymous with an improvement in the road behaviour, while retaining an acceptable level of hysteresis and thus of rolling resistance, in comparison with the conventional sublayer.

TABLE 1

| Composition No. | C.1 | C.2 |
|---|---|---|
| NR (1) | 50 | — |
| BR (2) | 50 | — |
| NBR (3) | — | 100 |
| Filler (4) | 55 | 55 |
| Antioxidant (5) | 1.5 | 1.5 |
| ZnO (7) | 3 | 3 |
| Stearic acid (8) | 0.5 | 0.5 |
| Accelerator (9) | 2 | 2 |
| Sulphur | 2 | 2 |

(1) Natural peptized rubber;
(2) BR comprising 4.3% of 1,2-, 2.7% of trans-1,4-, 93% of cis-1,4- (Tg = −106° C.);
(3) NBR (“Krynac 3370F” from Lanxess);
(4) Carbon black N683 (ASTM grade);
(5) N-(1,3-Dimethylbutyl)-N-phenyl-para-phenylenediamine (Santoflex 6-PPD from Flexsys);
(6) DPG = diphenylguanidine (“Perkacit DPG” from Flexsys);
(7) Zinc oxide (industrial grade, Umicore);
(8) Stearin (“Pristerene” from Uniquema);
(9) N-Dicyclohexyl-2-benzothiazolesulphenamide (“Santocure CBS” from Flexsys).

TABLE 2

| Composition No. | C.1 | C.2 |
|---|---|---|
| EM10 | 7.8 | 9.5 |
| EM100 | 6 | 6.5 |
| tan(δ)ₘₐₓ at 23° C. | 0.11 | 0.16 |

TABLE 3

| Composition No. | C.1 | C.2 |
|---|---|---|
| D = 3.5 mm | 100 | 100 |
| D = 2 mm | 100 | 100 |
| D = 1 mm | 80 | 100 |
| D = 0 mm | 60 | 100 |

1- Radial tire for a motor vehicle, comprising:
a crown surmounted by a tread provided with at least one radially outer elastomer layer intended to come into contact with the road when the tire is rolling;
two non-stretchable beads, two sidewalls connecting the beads to the tread, a carcass reinforcement passing into the two sidewalls and anchored in the beads;
the crown being reinforced by a crown reinforcement or belt positioned circumferentially between the carcass reinforcement and the tread;
a radially inner elastomer layer, known as tread “sublayer”, having a formulation different from the formulation of the radially outer elastomer layer, this sublayer being positioned between the radially outer layer (tea) and the belt,
wherein the said sublayer comprises a rubber composition comprising at least from 30 to 100 phr of a nitrile/butadiene rubber having a content of butadiene units of between 40% and 90% by weight and more than 30 phr of a reinforcing filler.

2- Tire according to claim 1, in which the nitrile/butadiene rubber is selected from the group consisting of butadiene/acrylonitrile copolymers (NBRs), styrene/butadiene/acrylonitrile copolymers (SNBRs) and the mixtures of these elastomers.

3- Tire according to claim 2, in which the nitrile/butadiene rubber is a butadiene/acrylonitrile copolymer (NBR).

4- Tire according to any one of claim 1, in which the content of nitrile/butadiene rubber is within a range from 40 to 100 phr.

5- Tire according to claim 1, in which the rubber composition additionally comprises a second diene elastomer other than the nitrile/butadiene rubber.

6- Tire according to claim 5, in which the rubber composition comprises at most 60 phr of second diene elastomer.

7- Tire according to claim 5, in which the second diene elastomer is selected from the group consisting of polybutadienes (BRs), synthetic polyisoprenes (IRs), natural rubber (NR), butadiene copolymers, isoprene copolymers and the mixtures of these elastomers.

8- Tire according to claim 7, in which the second diene elastomer is selected from the group consisting of natural rubber (NR), polybutadienes and the mixtures of these elastomers.

9- Tire according to claim 1, in which the reinforcing filler comprises carbon black, silica or a mixture of carbon black and silica.

10- Tire according to claim 9, in which the content of reinforcing filler is between 30 and 100 phr.
